(19) United States
(12) Patent Application Publication
(10) Pub. No.: US 2026/0322043 A1
(43) Pub. Date: Oct. 15, 2026

(54) TYPE-C CONNECTOR AND TYPE-C CHARGING CABLE

(71) Applicant: ifanr Inc., Sheridan, WY (US)

(72) Inventors: Weixing WANG, Sheridan, WY (US); Xiaogang LIAN, Sheridan, WY (US)

(73) Assignee: ifanr Inc., Sheridan, WY (US)

(21) Appl. No.: 19/235,531

(22) Filed: Jun. 11, 2025

(30) Foreign Application Priority Data
Apr. 10, 2025 (CN) 202510447480.4

(51) Int. Cl. H01R 13/6598; H01R 13/66; H01R 24/60

(52) U.S. Cl. CPC H01R 13/6598; H01R 13/6658; H01R 24/60

(57) ABSTRACT

A Type-C connector comprises a plug outer shell, longitudinally-oriented with a racetrack-shaped transverse cross-section; a plug contact assembly, encased in the plug outer shell, a rear end of the plug contact assembly providing electrical connections with external wires; and a protective housing, encasing a rear end of the plug outer shell to protect the electrical connections. Connecting sections on wide sides at the rear end of the plug outer shell extend into and connect to the protective housing; the connecting sections extend longitudinally from wide sides of the rear end of the plug outer shell, at least one transverse notch is defined on at least one narrow side of the rear end of the plug outer shell, and the protective housing corresponding to the at least one narrow side is embedded into the at least one transverse notch. This reduces the transverse width of the protective housing.

### FIELD

The present invention belongs to the technical field of Type-C connectors, in particular to a Type-C connector and a Type-C charging cable.

### BACKGROUND

A Type-C connector features a front-to-back oriented metal shield (plug outer shell), and a connector body (plug contact assembly) is provided in the metal shield. The shield offers physical and electromagnetic protection for the connector body, reducing external interference. The rear end of the connector body extends beyond the shield and is electrically connected to a PCB (Printed Circuit Board). A Type-C charging cable includes the Type-C connector and a cable. A front end of the cable is electrically connected to the PCB, while a rear end is linked to a power supply device. The front end of the connector body connects to a device requiring charging. The power supply device charges the target device via the Type-C charging cable. An insulating protective housing is placed at the back of the shield to protect the PCB and electrical connections. To enhance the structural robustness of the Type-C connector during plugging and unplugging, the shield is typically connected to the protective housing. Currently, the rear end of the shield is directly embedded in the protective housing, which then encases the rear end of the shield. In this case, the protective housing must be wider than the shield, protruding transversely beyond the shield, with a protruding transverse dimension roughly equal to a thickness of the protective housing. It is difficult to narrow the transverse width of the protective housing.

### SUMMARY

It is desired to provide a Type-C connector with a narrowed transverse width of a protective housing. It also desired to provide a Type-C charging cable with a similarly narrowed protective housing on its Type-C connector.

To address the aforementioned technical issues, the present invention provides a Type-C connector, comprising: a plug outer shell, longitudinally-oriented with a racetrack-shaped transverse cross-section; a plug contact assembly, encased in the plug outer shell, a rear end of the plug contact assembly providing electrical connections with external wires; and a protective housing, encasing a rear end of the plug outer shell to protect the electrical connections; wherein connecting sections on wide sides at the rear end of the plug outer shell extend into and connect to the protective housing; the connecting sections extend longitudinally from wide sides of the rear end of the plug outer shell uncovering the left and/or right ends at the rear end of the plug outer shell, at least one transverse notch is defined on at least one narrow side of the rear end of the plug outer shell, and the protective housing corresponding to the at least one narrow side is embedded into the at least one transverse notch.

Further, the protective housing has the same transverse width as a front end of th plug outer shell transverse width; or, the protective housing has a less transverse width than a front end of the plug outer shell; or, the protective housing has a greater transverse width than a front end of the plug outer shell, and a transverse width L1 of a protrusion beyond the plug outer shell is less than a thickness L2 of a housing body of the protective housing.

Further, the connecting sections has a transverse width of 7~7.8 mm, and the transverse notch has a transverse width of 0.2~0.8 mm.

Further, the connecting sections has the same transverse width as the rear end of the plug contact assembly and only covers the rear end of the plug contact assembly.

Further, the Type-C connector comprises a PCB for the electrical connections to external wires, wherein the rear end of the plug contact assembly is electrically connected to the PCB for indirectly connecting to external wires, and the protective housing encases the PCB and the electrical connections for protection.

Further, the connecting section, the rear end of the plug contact assembly, and the PCB have the same transverse width and are aligned longitudinally. The connecting section only covers the rear end of the plug contact assembly.

The present invention provides a Type-C charging cable, comprising a Type-C connector according to the above and a cable, wherein the cable extends forwards from a front end of the Type-C connector into the protective housing, and is electrically connected to the plug contact assembly.

The present invention provides a Type-C charging cable, comprising a longitudinally-oriented Type-C connector and a cable connected to a rear end of the Type-C connector, the cable extending forwards into the Type-C connector for electrically connecting to the Type-C connector; the Type-C connector comprising:
a plug outer shell, longitudinally-oriented with a racetrack-shaped transverse cross-section;
a plug contact assembly, encased in the plug outer shell, a rear end of the plug contact assembly electrically connected to the cable; and
a protective housing, insulatedly encasing a rear embedded section of the plug outer shell and a front end of the cable for protection;
wherein a transverse notch is defined at either transverse end of the embedded section to allow a wall of a housing body of the protective housing to fit into.

Further, a transverse width of the protective housing is equal to a transverse width of a front end of the plug outer shell; or, a transverse width of the protective housing is less than a transverse width of a front end of the plug outer shell; or, a transverse width of the protective housing is greater than a transverse width of a front end of the plug outer shell by less than a thickness of the wall of the housing body at either transverse end.

Further, the Type-C connector comprises a PCB encased in the protective housing, rear end of the plug contact assembly is exposed in the plug outer shell and is electrically connected to the PCB, and the PCB has the same transverse width as the rear end of the plug contact assembly and is aligned longitudinally with the plug contact assembly.

Further, a front portion of the protective housing encases and protects electrical connections between the PCB and the plug contact assembly, as well as a rear end of the plug contact assembly.

Further, the embedded section comprises an upper connecting section and a lower connecting section respectively extending from an upper wide side and a lower wide side at the rear end of the plug outer shell.

Further, the upper connecting section and the lower connecting section have the same transverse width as a rear end of the plug contact assembly 1, which is 7~7.8 mm.

Further, a left transverse notch and a right transverse notch with a transverse width of 0.2~0.8 mm are defined at a left narrow side and a right narrow side of the rear end of the plug outer shell.

Further, the plug outer shell is metal, and the protective housing comprises the housing body and insulating adhesive injected inside the housing body.

In the present invention, since the connecting sections does not cover the left and/or right ends of the plug outer shell but leaves a transverse notch on the narrow side of the rear end of the plug outer shell, a part of the protective housing corresponding to the narrow side does not need to protrude outside the rear end of the plug outer shell as in existing technologies. Instead, it is embedded into the transverse notch. This naturally reduces the transverse width of the protective housing, allowing it to be narrowed transversely. The protective housing can be designed to have the same transverse width as the plug outer shell, be narrower than the plug outer shell, or be wider than the plug outer shell but with a protrusion beyond the plug outer shell is less than a thickness of the protective housing.

### BRIEF DESCRIPTION OF THE DRAWINGS

FIG. 1 is a schematic diagram of a Type-C charging cable according to an embodiment of the present invention;

FIG. 2 is an exploded view of the Type-C charging cable in FIG. 1;

FIG. 3 is a schematic diagram of a Type-C connector in FIG. 2 with a protective housing removed;

FIG. 4 is a schematic diagram of a front part of the Type-C connector;

FIG. 5 is a front view of the Type-C connector;

FIG. 6 is a front view of a Type-C connector in another embodiment, where the protective housing is narrower than the plug outer shell transversely; and

FIG. 7 is a front view of a Type-C connector in another embodiment, where the protective housing is wider than the plug outer shell transversely, but a transverse width of a protrusion of the protective housing beyond the plug outer shell is less than a thickness of the protective housing.

### DESCRIPTION OF THE EMBODIMENTS

The invention will be described in further detail below in conjunction with specific embodiments.

In a Type-C connector, a rear end of the plug outer shell used for connecting the protective housing is referred to as an embedded section (connecting sections). In existing designs, the cross-sectional shape of the embedded section is usually identical to a front end of the plug outer shell, i.e., in a left-right oriented racetrack shape. The embedded section not only connects but also protects the rear end of the plug contact assembly, hence the shape is designed as a transversely oriented racetrack. However, this design causes the part of the protective housing corresponding to the narrow side of the rear end of the plug outer shell to transversely protrude outside from the narrow side of the plug outer shell, making it difficult to narrow the protective housing transversely.

Further research by the inventors revealed that a rear end of the plug contact assembly is primarily concentrated on the middles of wide sides of the rear end of the plug outer shell. In other words, two transverse ends of the rear end of the plug outer shell play virtually on functional roles. Based on this, an innovative design of a Type-C connector is proposed, wherein connecting sections on wide sides at the rear end of the plug outer shell extend into and connects to the protective housing, not covering the left and/or right ends of the plug outer shell. This leaves a transverse notch on the narrow side of the rear end of the plug outer shell. A part of the protective housing corresponding to the narrow side is embedded into the notches, eliminating the need for the protective housing to protrude outside the narrow side of the rear end of the plug outer shell as in existing technologies. Consequently, a transverse width of the protective housing can be reduced. The protective housing can be designed to have the same transverse width as the plug outer shell, be narrower than the plug outer shell, or be wider than the plug outer shell but with a protrusion beyond the plug outer shell's outer side that is less than the protective housing's thickness.

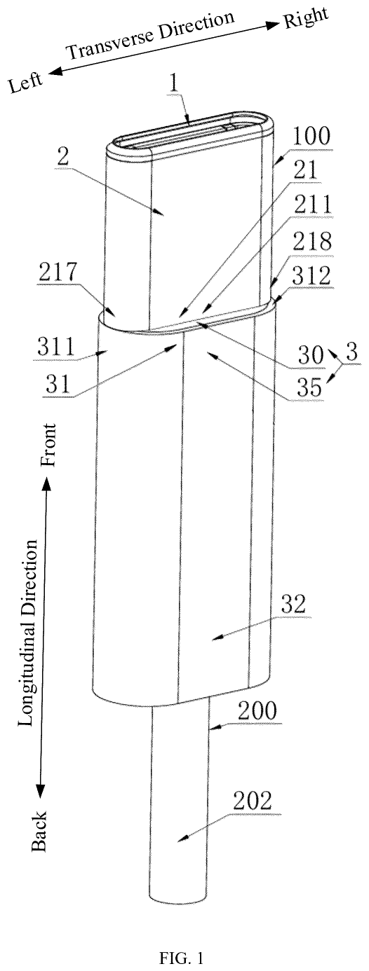

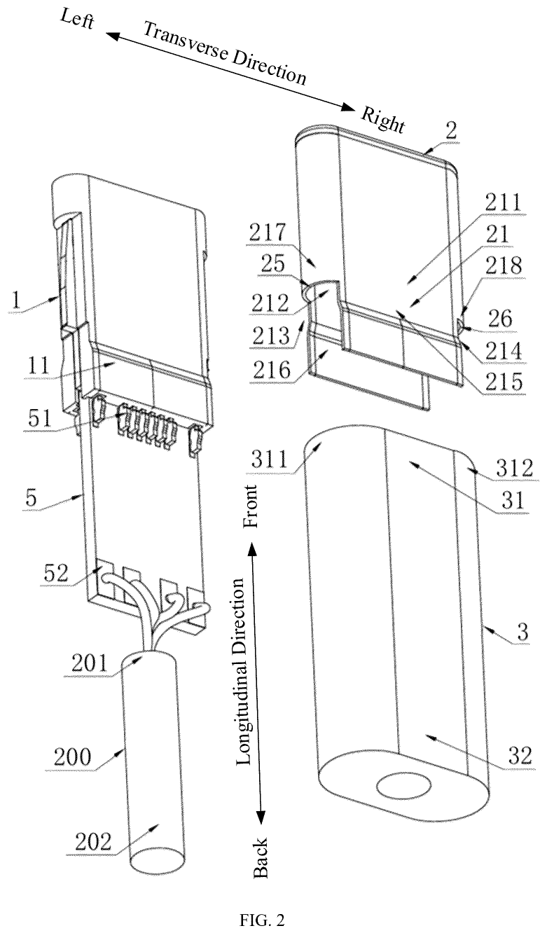

A Type-C charging cable, as shown in FIGS. 1 and 2, includes a longitudinal-direction (front-to-back) oriented Type-C connector 100 and a cable 200. A front end 201 of the cable 200 extends forwards from a rear end of the Type-C connector 100 into the Type-C connector 100, and a rear end 202 is connected to a power supply device (not shown). A front end of the Type-C connector 100 is connected to a device (not shown) requiring charging. The power supply device charges the target device via the Type-C charging cable. The Type-C connector 100 includes a longitudinal-direction (front-to-back) oriented metal plug outer shell 2. A plug contact assembly 1 is enclosed in the plug outer shell 2. The plug outer shell 2 is flat and has a rectangular shape with rounded corners, featuring a symmetrical design that allows for reversible plugging. Thus, the plug outer shell 2 has a racetrack-shaped transverse cross-section. A rear end 11 of the plug contact assembly 1 is exposed in the plug outer shell 2 and is electrically connected to a PCB 5. In the illustrated embodiment, the PCB 5 has the same transverse width as the rear end 11 of the plug contact assembly 1, and is aligned longitudinally with the plug contact assembly 1. In other embodiments, the PCB 5 can be narrower than or wider than the rear end 11 of the plug contact assembly 1. The width relationship between the PCB 5 and the rear end 11 merely requires that the electrical connection therebetween can be maintained.

An insulating protective housing 3 that protects the PCB 5 encases the PCB 5. The protective housing 3 includes a housing body 35 and insulating adhesive 30 injected inside the housing body 35. A front portion 31 of the protective housing 3 encases and protects electrical connections 51 between the PCB 5 and the plug contact assembly 1, as well as the rear end 11 of the plug contact assembly 1. The front end 201 of the cable 200 specifically extends from a rear end of the Type-C connector 100 into the protective housing 3 and is electrically connected to a rear end of the PCB 5, thereby indirectly electrically connected to the plug contact assembly 1. A rear portion 32 of the protective housing 3 encases and protects electrical connection 52 between the PCB 5 and the cable 200, as well as the front end 201 of the cable 200. During use, the Type-C connector 100 electrically connects to the device requiring charging via the plug contact assembly 1. The power supply device sequentially charges the target device via the cable 200, the PCB 5, and the plug contact assembly 1. In the illustrated embodiment, the protective housing 3 features a horizontally elongated oval shape (similar to the racetrack profile of the plug outer shell 2), with semicircular ends and parallel straight edges in the middle. In other embodiments, the protective housing 3 can be oblong/elliptical-shaped, such as capsule-shaped, rectangular with rounded corners, rectangular with sharp corners, etc.

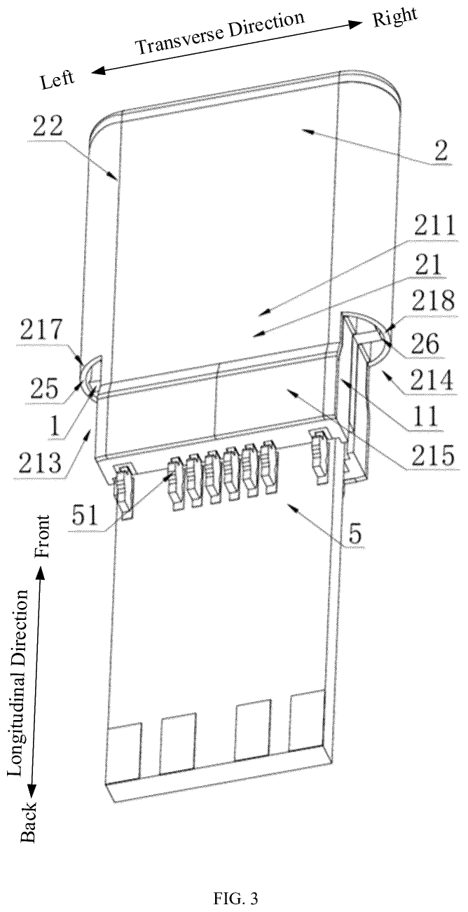

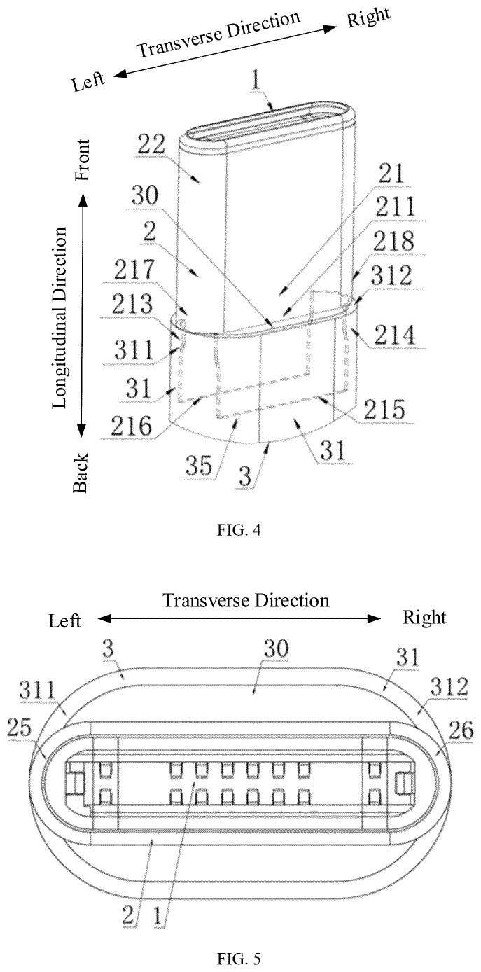

As shown in FIG. 2, an embedded section at the rear end 21 includes an upper connecting section 215 and a lower connecting section 216 respectively extending from an upper wide side 211 and a lower wide side 212 at a rear end 21 of the plug outer shell 2. The upper connecting section 215 and the lower connecting section 216 have the same transverse width as the rear end 11 of the plug contact assembly 1, which is 7~7.8 mm (preferably 7.3mm). As shown in FIG. 3, the upper connecting section 215 and the lower connecting section 216 only cover the rear end 11 of the plug contact assembly 1 and not a left end 25 and a right end 26 of the plug outer shell 2. This leaves a left transverse notch 213 and a right transverse notch 214 with a transverse width of 0.2~0.8 mm at a left narrow side 217 and a right narrow side 218 of the rear end 21 of the plug outer shell 2. As shown in FIG. 4, the upper connecting section 215 and the lower connecting section 216 of the plug outer shell 2 are inserted into the protective housing 3 for connection. A left front end 311 and a right front end 312 of the housing body 35 respectively correspond to the left narrow side 217 and the right narrow side 218 of the rear end 21 of the plug outer shell 2, and are transversely embedded into the left transverse notch 213 and the right transverse notch 214 at the rear end 21 of the plug outer shell 2. There is no need to protrude outside the left narrow side 217 and the right narrow side 218 of the rear end 21 of the plug outer shell 2 as in existing technologies. This naturally reduces the transverse width of the protective housing 3, allowing it to be transversely narrowed.

As shown in FIG. 5, the protective housing 3 has the same transverse width as the plug outer shell 2. That is, a transverse width of the protective housing 3 is equal to a transverse width of a front end 22 of the plug outer shell 2. A Type-C interface typically has a length of around 8.3-8.4 mm and a thickness of approximately 2.4-2.6 mm. Thus, the protective housing 3 has a transverse width of 8.3-8.4 mm, in the embodiment of FIG. 5.

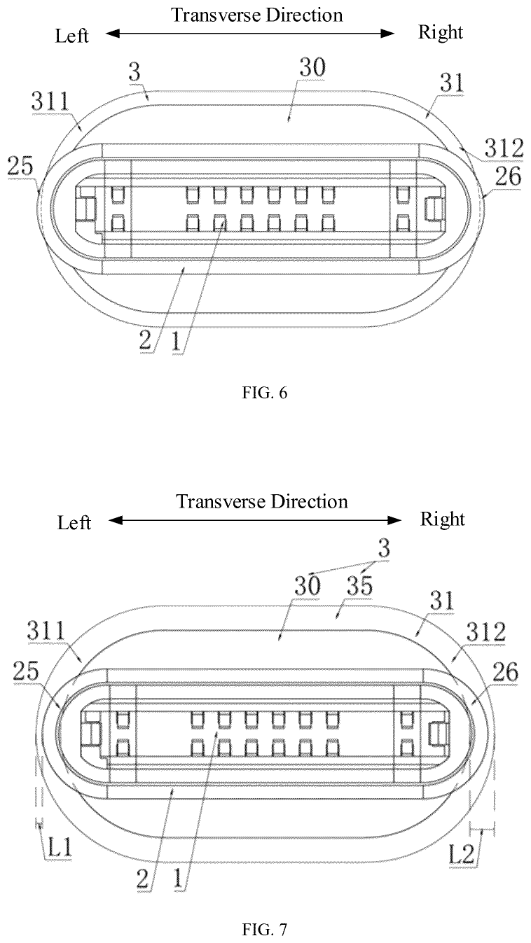

In other embodiments, as shown in FIG. 6, the protective housing 3 is narrower than the plug outer shell 2 transversely. That is, a transverse width of the protective housing 3 is less than a transverse width of the front end 22 of the plug outer shell 2.

Alternatively, as shown in FIG. 7, the protective housing 3 is wider than the plug outer shell 2 transversely, but a transverse width L1 of a protrusion beyond the plug outer shell 2 is less than a thickness L2 of the housing body 35 of the protective housing. That is, a transverse width of the protective housing 3 is greater than a transverse width of the front end 22 of the plug outer shell 2 by less than a thickness of the wall of the housing body 35 at either transverse end.

In the embodiment as shown in FIGS. 3 and 5, the upper connecting section 215 and the lower connecting section 216 of the plug outer shell 2, the rear end 11 of the plug contact assembly 1, and the PCB 5 have the same transverse width, and are aligned longitudinally. Provided that the protective housing 3 covers any one of them transversely, it is sufficient to simultaneously cover the others. In other embodiments, if the upper connecting section 215 and the lower connecting section 216 of the plug outer shell 2, the rear end 11 of the plug contact assembly 1, and the PCB 5 have different transverse widths, the protective housing 3 must cover aolfl them transversely.

In another embodiment, the upper connecting section 215 and the lower connecting section 216 of the plug outer shell 2 are wider transversely than the rear end 11 of the plug contact assembly 1. This results in the left transverse notch 213 and the right transverse notch 214 smaller on the left narrow side 217 and the right narrow side 218 of the rear end 21 of the plug outer shell 2. To ensure that the protective housing 3 has the same transverse width as the plug outer shell 2 as shown in FIG. 5, or is narrower than the plug outer shell 2 as shown in FIG. 6, or is wider than the plug outer shell 2 but with the transverse width L1 less than the thickness L2 as shown in FIG. 7, the protective housing 3 must be thinner accordingly.

In another embodiment, the upper connecting section 215 and the lower connecting section 216 of the plug outer shell 2 cover the right end 26 but not the left end 25. This leaves a left transverse notch 213 at the left narrow side 217 of the rear end 21 of the plug outer shell 2. The left front end 311 of the protective housing 3 is transversely embedded into the left narrow side 217 and the right narrow side 218. To ensure that the protective housing 3 has the same transverse width as the plug outer shell 2 as shown in FIG. 5, or is narrower than the plug outer shell 2 as shown in FIG. 6, or is wider than the plug outer shell 2 but with the width L1 less than the thickness L2 as shown in FIG. 7, the protective housing 3 must be thinner accordingly.

The above description is merely for explaining the embodiments of the invention and is not intended to limit the patent protection scope of the invention. All inessential variations or substitutions made by those skilled in the art based on the invention should still fall within the protection scope of the invention.

What is claimed is:

1. A Type-C connector, comprising:
a plug outer shell, longitudinally-oriented with a racetrack-shaped transverse cross-section;
a plug contact assembly, encased in the plug outer shell, a rear end of the plug contact assembly providing electrical connections with external wires; and
a protective housing, encasing a rear end of the plug outer shell to protect the electrical connections;
wherein connecting sections on wide sides at the rear end of the plug outer shell extend into and connect to the protective housing; the connecting sections extend longitudinally from wide sides of the rear end of the plug outer shell uncovering the left and/or right ends at the rear end of the plug outer shell, at least one transverse notch is defined on at least one narrow side of the rear end of the plug outer shell, and the protective housing corresponding to the at least one narrow side is embedded into the at least one transverse notch.

2. The Type-C connector as claimed in claim 1, wherein the protective housing has the same transverse width as a front end of the plug outer shell transverse width; or, the protective housing has a less transverse width than a front end of the plug outer shell; or, the protective housing has a greater transverse width than a front end of the plug outer shell, and a transverse width L1 of a protrusion beyond the plug outer shell is less than a thickness L2 of a housing body of the protective housing.

3. The Type-C connector as claimed in claim 1, wherein the connecting sections has a transverse width of 7~7.8 mm, and the transverse notch has a transverse width of 0.2~0.8 mm.

4. The Type-C connector as claimed in claim 1, wherein the connecting sections has the same transverse width as the rear end of the plug contact assembly and only covers the rear end of the plug contact assembly.

5. The Type-C connector as claimed in claim 1, comprising a PCB for the electrical connections to external wires, wherein the rear end of the plug contact assembly is electrically connected to the PCB for indirectly connecting to external wires, and the protective housing encases the PCB and the electrical connections for protection.

6. The Type-C connector as claimed in claim 5, wherein the connecting section, the rear end of the plug contact assembly, and the PCB have the same transverse width and are aligned longitudinally. The connecting section only covers the rear end of the plug contact assembly.

7. A Type-C charging cable, comprising a Type-C connector according to claim 1 and a cable, wherein the cable extends forwards from a front end of the Type-C connector into the protective housing, and is electrically connected to the plug contact assembly.

8. A Type-C charging cable, comprising a longitudinally-oriented Type-C connector and a cable connected to a rear end of the Type-C connector, the cable extending forwards into th Type-C connector for electrically connecting to the Type-C connector; the Type-C connector comprising:
a plug outer shell, longitudinally-oriented with a racetrack-shaped transverse cross-section;
a plug contact assembly, encased in the plug outer shell, a rear end of the plug contact assembly electrically connected to the cable; and
a protective housing, insulatedly encasing a rear embedded section of the plug outer shell and a front end of the cable for protection;
wherein a transverse notch is defined at either transverse end of the embedded section to allow a wall of a housing body of the protective housing to fit into.

9. The Type-C charging cable as claimed in claim 8, wherein a transverse width of the protective housing is equal to a transverse width of a front end of the plug outer shell; or, a transverse width of the protective housing is less than a transverse width of a front end of the plug outer shell; or, a transverse width of the protective housing is greater than a transverse width of a front end of the plug outer shell by less than a thickness of the wall of the housing body at either transverse end.

10. The Type-C charging cable as claimed in claim 9, wherein the Type-C connector comprises a PCB encased in the protective housing, a rear end of the plug contact assembly is exposed in the plug outer shell and is electrically connected to the PCB, and the PCB has the same transverse width as the rear end of the plug contact assembly and is aligned longitudinally with the plug contact assembly.

11. The Type-C charging cable as claimed in claim 10, wherein a front portion of the protective housing encases and protects electrical connections between the PCB and the plug contact assembly, as well as a rear end of the plug contact assembly.

12. The Type-C charging cable as claimed in claim 9, wherein the embedded section comprises an upper connecting section and a lower connecting section respectively extending from an upper wide side and a lower wide side at the rear end of the plug outer shell.

13. The Type-C charging cable as claimed in claim 12, wherein the upper connecting section and the lower connecting section have the same transverse width as a rear end of the plug contact assembly 1, which is 7~7.8 mm.

14. The Type-C charging cable as claimed in claim 12, wherein a left transverse notch and a right transverse notch with a transverse width of 0.2~0.8 mm are defined at a left narrow side and a right narrow side of the rear end of the plug outer shell.

15. The Type-C charging cable as claimed in claim 9, wherein the plug outer shell is metal, and the protective housing comprises the housing body and insulating adhesive injected inside the housing body.
